(19) United States
(12) Patent Application Publication
(10) Pub. No.: US 2002/0133828 A1
(43) Pub. Date: Sep. 19, 2002

(54) Method, apparatus and system for video delivery using head-end pass through

(76) Inventor: Mark J. Foster, Palo Alto, CA (US)

Correspondence Address: GLENN PATENT GROUP, 3475 EDISON WAY, SUITE L, MENLO PARK, CA, 94025, US

(21) Appl. No.: 09/811,232

(22) Filed: Mar. 16, 2001

(51) Int. Cl. H04N 7/173; H04N 7/16

(52) U.S. Cl. 725/110; 725/146; 725/116; 725/109

(57) ABSTRACT

Web pages with integrated video are rendered in a head-end without the video content. The head-end creates key frames that depict the graphical representation of web pages, again exclusive of program video. Key frames arriving at set top boxes are written to a background display plane and signal that program video redirected by head-end to set top box should be rendered to an overlay display plane.

### BACKGROUND OF THE INVENTION

1. Technical Field

This invention pertains to the field of distribution of cable video signals from a head-end to a set-top box.

2. Description of the Prior Art

Cable television distribution systems were originally developed to bring television signals to geographically isolated communities. The isolated communities found that the quality of their television service was in many aspects superior to that of their city counterparts that received television signals off the airwaves. Because of this superior quality, cable television service was able to penetrate urban communities where television reception was otherwise available. Suffice it to say that cable television systems have proliferated widely and today many households enjoy the benefits of a cable television connection.

Cable television has many intrinsic advantages over off-air reception, especially in the field of digital television. Where off-air transmission must contend with a problematic medium, i.e. open air space, cable television offers a controlled distribution system. Problems such as multi-path errors are simply non-existent or are easily contained. Given the regulated nature of the delivery medium, cable television is much more suited to digital transmission.

In digital television, compressed digital video signals are conveyed to subscribers attached to the cable system. The digital video signals can be referred to as program streams. Subscribers can select one of a number of program streams carried on the cable. A modulated carrier is used to transmit digital information to the subscribers. The most common form of modulation is a multi-state modulation technique. Multi-state modulation techniques allow more than two states to be represented by modulating either the amplitude of the carrier, the phase of the carrier or both. One modulation technique that modulates both amplitude and phase is called quadrature amplitude modulation (QAM).

By using a QAM modulated carrier, the cable television distribution system is able to transmit massive amounts of digital information in short time frames. In a simple but relevant comparison, upwards of fifteen digital program streams can be transmitted in the bandwidth normally allocated to just one analog television channel. This expanded bandwidth capability has caused some to envision systems where the cable television distribution system is used not only for digital television, but delivery of high speed data services as well. These visions have led to modern cable systems that offer Internet access as part of the suite of services offered to subscribers.

Integrating the Internet with television programming is the next plateau. Using a software tool called a browser, subscribers can retrieve web pages from a server. These web pages are presented to a subscriber on the television screen and the subscriber can navigate through web pages using buttons on a remote control. True integration of the Internet with video programming demands that subscribers select video programs through hyperlinks on a web page. The hyperlinks can then reference either video streams, such as would be the case with a broadcast channel, or video files. In the latter case, a true video-on-demand system can be realized.

One unfortunate artifact of the integrated Internet-Television paradigm is that all data received from the head-end is received using a network protocol. In many cases, the TCP/IP protocol is used. This network oriented data delivery scheme is imputed not only to web pages, but to program video as well. To realize this type of functionality, each subscriber must be outfitted with a rather sophisticated, and therefore expensive set top box. The set top box must include a high-speed processor coupled to a graphics controller. The high-speed processor is also coupled to a network interface that allows communication with the head-end. In this prior art scheme, the set top box functions as a web browser much akin to a personal computer connected to the Internet.

Because cable television services are extremely cost sensitive, it is desirable to reduce the cost of the set top box. But doing so is contra to the processing performance needed to support the integrated Internet-Television paradigm. One novel method for reducing the need for processing power at the set top box has been disclosed in the Applicants prior application entitled “SYSTEM AND METHOD OF A MULTI-DIMENSIONAL PLEX COMMUNICATION NETWORK AND NODE THEREOF”, Ser. No. 09/679,115. In that disclosure, a cable television head-end is described that comprises a suite of loosely coupled processors. The loosely coupled processors communicate with each other using high-speed network connections to form a large array. This array of processors offers economies of scale that can not be achieved in the alternative where high-performance set top boxes are installed at each subscriber site. Installed in a central facility, the head-end can economically contend with browser execution and high-speed network interface.

The head-end processor array is able to support a plurality of simultaneous web browser instantiations. Each instance of a browser services one subscriber in the cable television system. Each instance of the browser has high-speed and immediate access to the Internet, enabling true video-on-demand and streaming video reception. The browser renders its graphic output to local memory within the head-end processing array. That graphic output is sampled periodically to create a sequence of image frames. These image frames are then compressed into a digital video stream. The digital video stream is then conveyed to the subscriber using the cable television distribution system. The set top box still needs a processor, but the computational requirement is greatly reduced. The set top box need only be capable of receiving digital television and this can be readily accommodated using a low-performance processor augmented by a low-cost, hardware based video stream decompressor.

The prior method exploits the ability of one processor in the processor array to execute a plurality of browser instantiations. The subscriber is presented with a video representation of the browsers' graphical output so that the set top box is not concerned with the execution of the browser or interface to a computer network. These features reduce the per-subscriber cost associated with integrated Internet services, but this method is compromised whenever video must be presented to the subscriber. Presenting video in a browser window implies that the video must be decompressed and then rendered into a video graphics window. In the centralized approach, the output of the browser, which then includes the rendered video program, must be compressed so that it can be transmitted to a less sophisticated set top box as a digital video stream. Herein lies the conundrum, using a centralized processor array to execute the browsers is efficient, but processing video is inefficient because once the video is decompressed, it must be rendered and then again recompressed so that it can be sent to the set top box. The need to decompress the video signal and then recompress that signal once it is rendered and merged into a graphic window is not only computationally wasteful and provides no sealing benefits.

What is needed is a method that not only takes advantage of the centralized execution of the browser software, but also eliminates the need to decompress video programs and then recompress them almost immediately thereafter. This method of the invention does this. A processor array located in a head-end executes a plurality of browser instantiations. Video streams that are received by the browser are not processed by the browser. Rather, they are forwarded to the set top box together with information pertinent to their presentation within the browsers' graphical output. When received at the set top box, the video streams can be decompressed in a manner analogous to that of a digital television stream.

### SUMMARY OF THE INVENTION

The present invention comprises a method and apparatus for delivering video to a subscriber wherein the video is integrated into a web browsing session. The apparatus comprises a system for delivering video according to the method. The system comprises a head-end, a plurality of set top boxes and a distribution system. The invention further comprises the individual system elements, i.e. a head-end and a set top box that implement the method of the present invention.

The system executes web browsers in a central head-end. A browser is a software element that receives page addresses from the subscriber, retrieves the description for the referenced pages and renders a graphical image according to the page description. The page address is received from the subscriber either by means of a navigation entry or a hyperlink. In the preferred embodiment, the page description is written in a page description language such as Hyper Text Markup Language, but any alternative mark-up language can be used.

The browser executes in the head-end and renders a page image description frame by interpreting the page description. This graphical output is sampled on a periodic basis to form a sequence of image frames. The image frames are directed to a compression mechanism in the head-end that creates a page description video stream. This page description video stream is then transmitted to the set top box where it is received and written to a display memory. Where program video must be integrated with the web page, a video source is received by the head end. The video source can be a compressed digital video stream. The Moving Picture Experts Group (MPEG) is one standard compression format and this is the compression format used in the preferred embodiment. Instead of rendering the program video in the centrally executed browser, the program video is merely routed to the set top box. This avoids an unnecessary decompression-recompression step that is computationally wasteful and that can degrade the quality of the video program.

The compression mechanism operating in the head-end is capable of creating a key frame based on the page description video stream. The set top box receives either the key frame or the page description video stream both of which depict the graphical output created by browser according to the page description. The set top box will then decompress either the page image description key frame or video stream and write the image into a display memory. The display memory is partitioned into planes comprising an overlay plane and a background plane. The page image description is normally written into the background plane. Program video that is routed to the set top box by the head-end is received and also written into the display memory. In the case of program video, the rendered images are written into the overlay memory plane such that the image of the video program is set forth on a non-transparent region of the overlay plane. The remainder of the overlay plane is made transparent so that the page description graphics written to the background plane can be displayed.

In an alternative embodiment, the program video can be rendered to the background plane and the overlay plane can be used to display the page image description for the web page. In this alternative, the overlay plane is made transparent only in the region corresponding to the program video presentation occurring in the background plane. Note that some video formats require translation to an MPEG 2 format that is suitable for a set top box. In the invention, that translated output is cached. This technique provides caching benefits for large-scale systems.

The page image description key frame or video stream is conveyed to the set top box using a multi-state modulated radio frequency carrier. Multi-state modulated carriers vary either the amplitude, the phase or the amplitude and phase of the carrier in order to represent the data being sent. In all of these variations, the number of states in any given modulation interval is more that one. In the preferred embodiment, quadrature amplitude modulation is used. A plurality of carriers operating at different frequencies can be propagated by the distribution system and a tuner is used in the set top box to select a desired carrier by its frequency. Program video is also transmitted to the set top box using this technique. In one alternative embodiment, the page description key frame can be directed to the set top box using a separate digital interface. This is the so-called out-of-band method.

According to the method of the present invention, a graphics controller in the set top box comprises a hardware decompressor that reconstitutes compressed image frames and writes these into the display memory. A software decompressor can support the method just as well. In either case, the decompressor can accept a display region in the form of a sized rectangle placed on the display screen or in the form of two diagonally opposing corners of a rectangle. The decompressor will then scale and render the video into the display region. One key aspect of the present invention is the capability of the set top box to distinguish between page description and program video. Page description video is frozen in the background plane after a web page graphic is fully rendered by the web browser executing in the head-end. In the preferred embodiment, a key frame is created when the web browser completes the page rendering process. The key frame can then be directly conveyed to the set top box and subsequently written into the background memory plane.

### BRIEF DESCRIPTION OF THE DRAWINGS

FIG. 1 is a block diagram that depicts centralized browser execution according to the present invention;

FIG. 2 is a block diagram of a set top box according to the present invention;

FIG. 3 is a flow diagram that depicts the method of delivering web page graphics and program video to a set top box when the program video must be integrated into the web page;

FIG. 3A is a block diagram depicting a video pass through mechanism according to the present invention;

FIG. 4 is a pictorial diagram of an exemplar video program selection menu background graphic; and

FIG. 5 is a pictorial diagram that depicts the overlay of video on top of a background graphic.

### DETAILED DESCRIPTION OF THE INVENTION

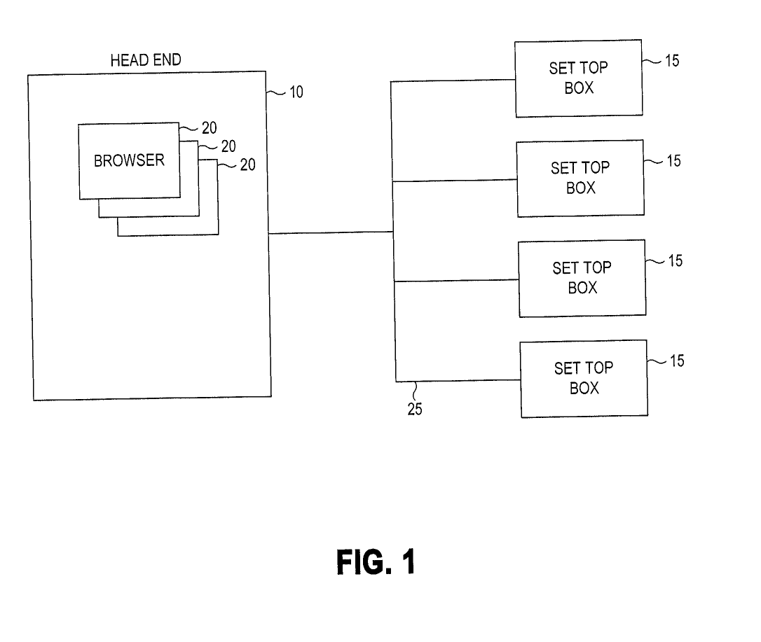

FIG. 1 is a block diagram that depicts centralized browser execution according to the present invention. A head-end 10 comprises a processor array that is able to execute a plurality of browser or browser services 20. One instance of the browser 20 is launched for each subscriber using a set top box 15. Each browser 20 in the head-end 10 generates a graphic output whenever a new page description is interpreted and thereafter rendered. The graphic output is sampled on a periodic basis and/or when content has been updated and each such sample is called a frame. The frames are sequentially routed to a video compressor. The video compressor uses the frames to create a compressed video stream for each browser. This video stream is called the page description video stream. Each of these page description video streams is then delivered to the corresponding set top box 15. The set top box 15 receives the video program stream, decompresses the video and presents it on a television screen viewed by a subscriber.

Upon initiation, each browser will retrieve a page description for a start-up page. The page description is written in a page description language. In the preferred embodiment, the Hyper-Text Markup Language (HTML) is used but any suitable markup language or extension thereof may be used. The browser executes in the head-end and renders a page image in a specialized rendering memory. The rendering memory is sampled on a periodic basis to produce a sequence of frames. These frames constitute the basis of a page description video stream. This process continues until the browser recognizes a need to present a program video stream in a browser window. Program video is distinguished from page description video in that program video is received either from a static file or from a streaming source.

Any digital video stream is normally conveyed to the set top box by way of a radio frequency (RF) carrier signal. In the preferred embodiment, the data stream modulates the carrier in order to produce a plurality of discrete states in a given interval of time. This type of modulation is referred to as multi-state modulation. Multi-state modulation comprises variation of either the amplitude, the phase or both amplitude and phase of a signal in a plurality of discrete quantum. Once such modulation method commonly used in cable television systems is quadrature amplitude modulation (QAM). QAM modulation varies the amplitude and the phase of a carrier wave according to the data. A QAM modulated signal is capable of carrying a plurality of video program streams. The program streams are time multiplexed prior to modulation of the carrier signal. The distribution system 25 can carry a plurality of modulated carriers; each centered at a different frequency.

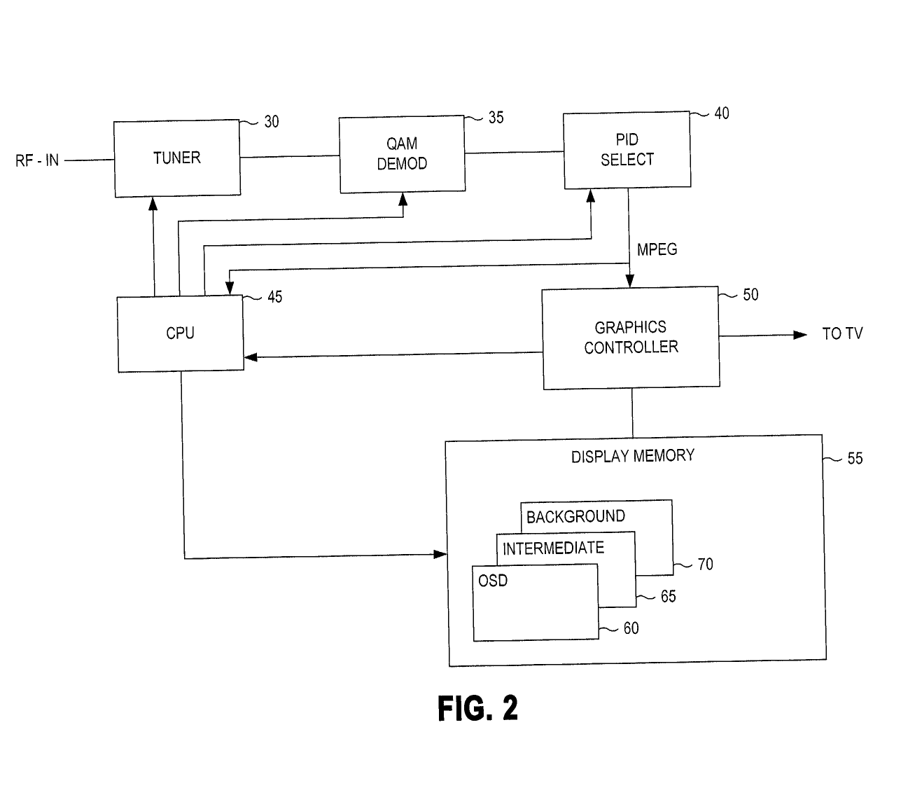

FIG. 2 is a block diagram of a set top box according to the present invention. In the preferred embodiment, the set top box 15 receives video signals that are carried on a radio frequency carrier wave. A tuner 30 receives RF energy. The tuner 30 selectively amplifies a carrier at a particular frequency while rejecting unwanted carriers at other frequencies. The selected carrier is then delivered to a multi-state demodulator 35. In the preferred embodiment a QAM demodulator is used. Because any given video program stream is time multiplexed with other program streams, a program identifier (PID) selector 40 is used to extract the desired video program stream. The output of the PID selector 40 comprises a compressed digital video stream. In the present embodiment, the compressed digital video stream comprises an MPEG stream.

The MPEG, or other compressed video program stream is directed either directly to a graphics controller 50 or to a central processing unit (CPU) 45. In the preferred embodiment, the graphics controller 50 comprises a hardware decompressor that accepts a sequence of compressed digital image frames and reconstitutes frame images by decompressing the sequence. In the case of a video program stream such as MPEG, the sequence of digital image frames comprises an initial image frame followed by a plurality of update frames. Each update frame carries information regarding the difference between the current image and the initial image frame. The graphics controller 50 writes the uncompressed frame images to the display memory 55 as they emerge from the decompression process.

In an alternative embodiment, the CPU 45 receives the sequence of digital image frames from the PID selector 40 and executes an instruction sequence that comprises a software decompressor. In this case, the output of the software decompressor is then directed directly to the graphics controller display memory 55. Once the image of a frame is written to the graphics memory 55 by either the CPU 45 or the hardware decompressor in the graphics controller 50, the graphics controller 55 creates a video signal that is delivered to a television set.

One key feature of the decompression capability provided either by the graphics controller 50 or the software decompression algorithms is the ability to render the video output to a specific portion of the display memory. This means that the decompression mechanism can accept a screen boundary wherein the video signal will be presented. The extents of the screen boundary can be specified either as a rectangle size together with the location of the rectangle or it can be specified by the location of two diagonally opposing corners of the rectangle. The hardware and software decompressors include a scaling engine that scales the rendered video output so as to fit the display extents. This aspect of the invention applies to transparency and/or windowing.

According to the present invention, the graphics controller 50 has the ability to partition the display memory 55 into display planes. The display memory 55 partition can be accomplished either logically or physically. In the present embodiment, the display memory 55 is partitioned into at least an overlay plane 60 and a background plane 70. In some embodiments, an intermediate memory plane 65 can be established. In operation, any image written into the overlay plane 60 will be presented on the display screen to the exclusion of any other image written to either the background plane 70 or the intermediate plane 65. The overlay plane 60 further comprises a plurality of transparency zones. Each of these transparency zones, once specified, causes the image written in the overlay plane 60 within that zone not to be displayed on the display screen. The intermediate plane 65, if used, also comprises a plurality of transparency zones. The transparency zones in the intermediate plane 65 can have varying degrees of transparency.

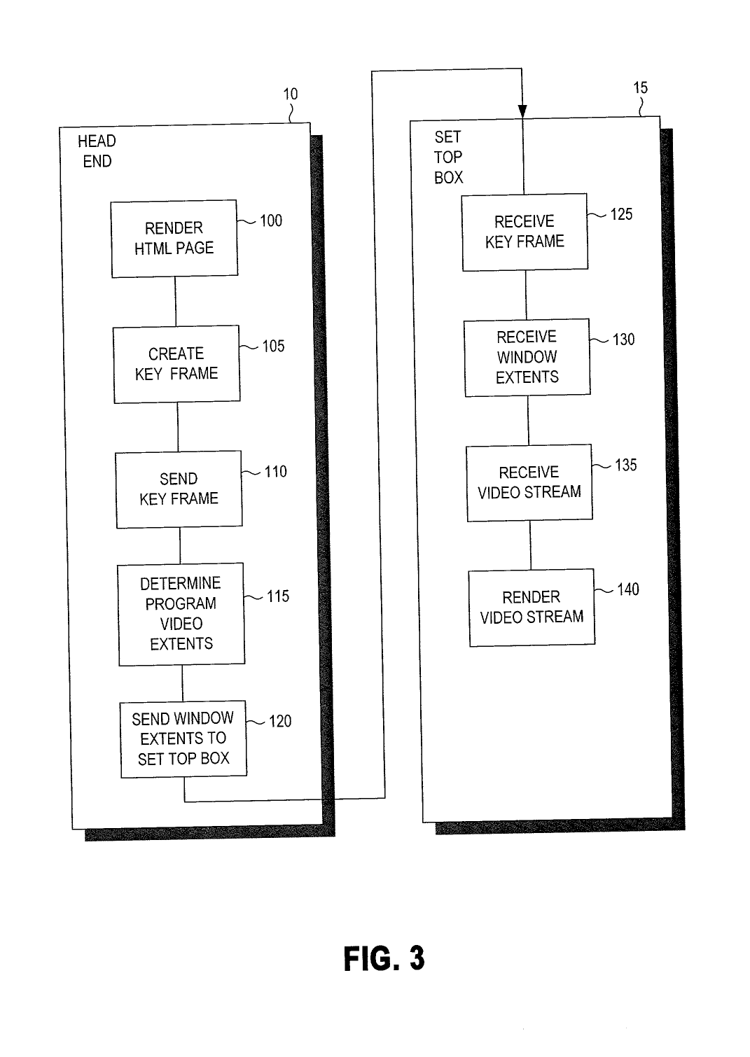

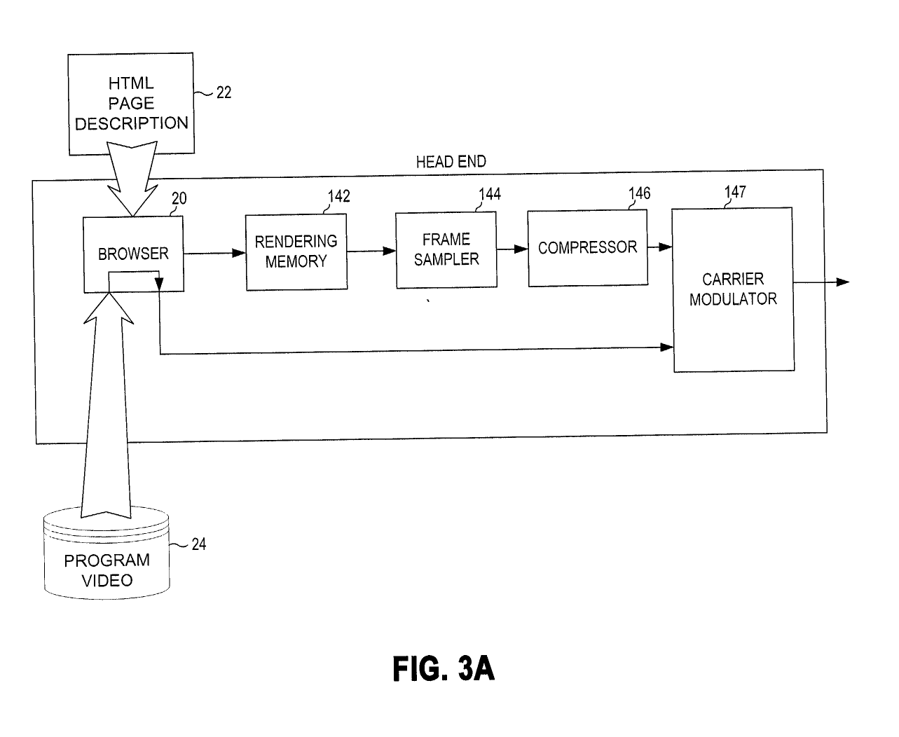

FIG. 3 is a flow diagram that depicts the method of delivering web page graphics and program video to a set top box when the program video must be integrated into the web page. Given the fact that the problem to be solved pertains to the delivery of video that is presented during a browser session, the first step (step 100) in the process is to render a graphic image for a web page. The web page is authored in a mark up language such as Hyper Text Markup Language (HTML). In operation, this web page will probably be an index page having one or more hyperlinks to video content. These hyperlinks can reference either streaming sources or static files. Where the hyperlink references a streaming source, the source can be a broadcast source. In the case where the hyperlink references a static source, that file may be a video-on-demand selection.

FIG. 3A is a block diagram depicting a video pass through mechanism according to the present invention. The graphic image for a web page description 22 is rendered by the web browser 20 and placed in a rendering memory 142 located in the head-end. Ordinarily or when content is updated, a frame sampler 144 captures the state of the rendering memory 142 on a periodic basis. The sample period is commensurate with the frame rate for a television video signal. The frame sampler 144 forwards sequential frame images to a compressor 146. The compressor 146 creates and delivers a page description video stream to a carrier modulator 147. The carrier modulator 147 modulates a carrier and delivers this modulated signal to the distribution system. This mechanism continuously delivers a video representation of the web browsers' graphical output to a set top box. This is called the page description video stream.

FIG. 3 further shows that once a web page 22 is rendered (step 100), the compressor 146 is instructed to create a key frame (step 105). The key frame is created only when the web browser recognizes that a program video stream 24 must be integrated into the web page, i.e. when a browsing session includes a video stream. The head-end will send the page image description key frame to the set top box (step 110). The browser 20 will then determine the size of the video presentation window and its location on the display screen (step 115). The window extents are also sent to the set top box (step 120).

Once the subscriber selects one of the hyperlink video program references, the browser 20 running in the head-end will retrieve the data from the program video source 24 or alternatively translated content may be cached and the hyperlinks rewritten to the cache location of the content. The browser will not decompress the program video stream. Rather, the browser 20 will route the program video stream directly to the carrier modulator 147 and command the carrier modulator to ignore the output of the compressor 146. The carrier modulator will modulate the carrier with the program video stream and deliver it to the distribution system.

The set top box receives the page description key frame (step 125). The set top box is able to distinguish the key frame from the ordinary page description video stream it regularly receives from the head-end. The page description key frame is decompressed and written to the display memory, specifically into the background plane 70. All video stream data arriving at the set top box subsequent to the arrival of the page description key frame is treated as program video.

Program video arriving at the set top box 15 (step 135) is routed to either the hardware decompressor in the graphics controller 50 or is processed by the software decompressor executed by the CPU 45. The hardware and software decompressors will render digital frame images depicting the program video into the overlay plane 60 (step 140). The decompressors will honor the display extents received in step 130 and will scale the program video to the size specified by the display extents. A special command issued by the browser and received by the set top box resets the graphics controller 50 so that the video streams are again directed to the background plane 70. This reset command also causes the entire overlay plane 60 to be made transparent.

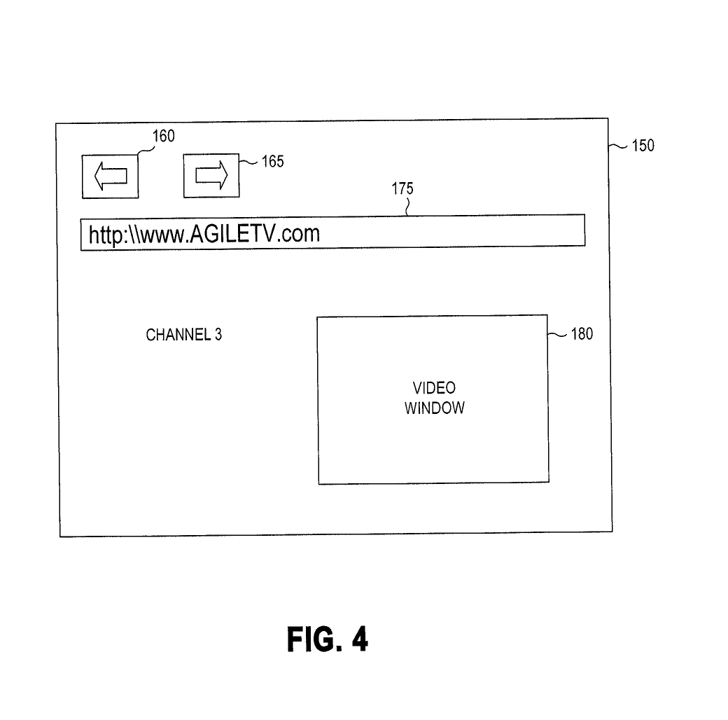

FIG. 4 is a pictorial diagram of an exemplar video program selection menu background graphic. The program selection menu background graphic depicts the display output as created by a web browser. The background graphic may contain a plurality of navigation controls such as forward and back buttons 160 and 165. The background graphic may further comprise a navigation address box 175. At least one hyperlink 180 will be contained in the page description. It should be noted that the substance of the menu page depicted in FIG. 4 and described herein is for illustrative purposes only and can be varied to meet specific requirements that may pertain to specific system operators and/or subscribers. In this illustrative example, the hyperlink 180 is a rectangular region. In this example, the rectangular region also depicts the extent and location at which the program video must be presented on the subscribers display.

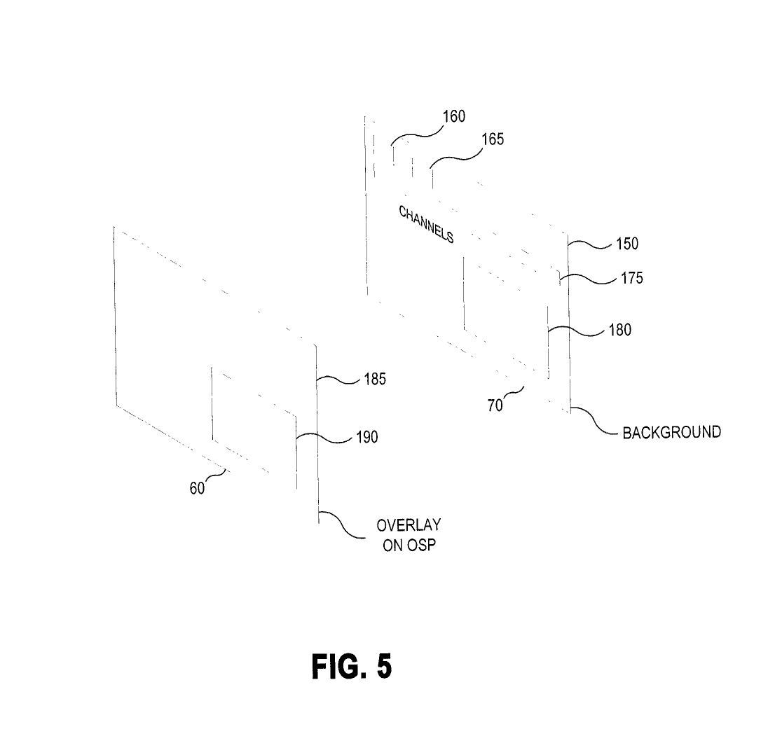

FIG. 5 is a pictorial diagram that depicts the overlay of video on top of a background graphic. As previously described, any background graphic is rendered by the browser 20 executing in the head-end 10. This background graphic is conveyed to the set top box 15 as a key frame. This page image frame description 150 is written into the background display memory plane 70. Once the set top box receives the key frame, program video is directed to the overlay display plane 60. The overlay display plane 60 is made transparent 185 except for a non-transparent region 190. The non-transparent region 190 comprises the region corresponding to the display extents for the program video presentation. The graphics controller 50 will create a composite output comprising the non-transparent overlay region 190 together with the contents of the background plane 70. This results in presentation of the video program stream on top of the background web page.

Alternative Embodiments

While this invention has been described in terms of several preferred embodiments, it is contemplated that alternatives, modifications, permutations, and equivalents thereof will become apparent to those skilled in the art upon a reading of the specification and study of the drawings. It is therefore intended that the true spirit and scope of the present invention include all such alternatives, modifications, permutations, and equivalents. Some, but by no means all of the possible alternative embodiments are described herein.

Each browser receives a program video stream from some source. In the present embodiment, compressed video streams are encoded according to the Moving Picture Experts Group (MPEG-2) standard. It should be noted that any compression standard could be used.

In the preferred embodiment, the background page description is delivered to the set top box using a portion of the bandwidth used to transport program video to the set top box. This method can be supplanted by delivering the background image representing the output of the web browser 20 by using an ancillary digital interface.

Also in the preferred embodiment, the web page rendered by the browser 20 is received by the set top box 15 and is written to the background plane 70. In this preferred embodiment, the video program stream is rendered into the overlay plane 60. As an alternative to this, the video could be rendered into the background plane 70. In this case, the overlay plane 60 is made transparent only in the video presentation region as depicted by the display extents. Other permutations of this method would render the video program into an intermediate plane 65. In this case, the page image description rendered by the browser 20 could be written into the overlay plane 60 or the background plane 70 with the proper opacity adjustments made to the proper planes to achieve the video overlay effect described herein.

The set top box 15 receives a key frame as an indication that the incoming video stream is shifting from browser graphic output to program video. The key frame is generated from the page description video stream generated by the compressor 146. The set top box can continue to receive the page description video stream into the background memory plane 70 until the web browser 20 has fully rendered a web page that must be integrated with program video. Once this is done, the browser could issue a command to the set top box to hold the latest image in the background memory 70. This command would signal the graphics controller 50 that the video stream should be regarded as program video and that the video stream should be directed to the overlay plane 60.

One benefit of the invention is that it offers a significant scaling benefit for a large scale system. When a translation (compression) is performed from a native format to a target, e.g. set top box, format a statistical analysis may be used to determine whether or not translated content should be cached, e.g. based upon popularity. A link to this content is then rewritten to access the cache instead of the source, and a compute intensive translation for future access to the content is avoided because the previously translated, and now cached, version of the content is available.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

We claim:

1. A method for delivering video to a set top box comprising:
rendering a page image in a head-end based on a page description written in a page description language;
creating a page image description frame according to said page image;
sending the page image description frame to a set top box;
receiving the page image description frame in said set top box;
painting the page image description frame in a display memory in said set top box;
receiving a video signal in said head end;
forwarding said video signal to said set top box;
receiving said video signal in said set top box; and
rendering a video image in said display memory in said set top box based on the video signal.

2. The method of claim 1 wherein the video signal received in the head end is a compressed digital video stream.

3. The method of claim 2 wherein the compressed digital video stream is an MPEG stream.

4. The method of claim 1 wherein the page image description frame is sent to and received by the set top box as a digital image.

5. The method of claim 1 wherein the page image description frame is sent to and received by the set top box as a video signal.

6. The method of claim 1 wherein the video signal received in the set top box is received on a multi-state modulated radio frequency carrier.

7. The method of claim 6 wherein the phase of the radio frequency carrier is varied according to the data to be conveyed thereby.

8. The method of claim 6 wherein the amplitude of the radio frequency carrier is varied according to the data to be conveyed thereby.

9. The method of claim 6 wherein the phase and amplitude of the radio frequency carrier are varied according to the data to be conveyed thereby.

10. The method of claim 1 wherein the video signal received in the set top box is received on a data channel.

11. The method of claim 1 wherein the video signal received in the set top box is a compressed digital video stream.

12. The method of claim 11 wherein the compressed digital video stream is an MPEG stream.

13. The method of claim 1 wherein the step of rendering a video image in said display memory is accomplished by:
extracting a sequence of compressed digital image frames from the video signal received in the set top box; and
directing the sequence of compressed digital image frames to a hardware decompressor that reconstitutes non-compressed digital image frames and writes the non-compressed digital image frames to a graphics memory.

14. The method of claim 1 wherein the step of rendering a video image in said display memory is accomplished by:
extracting a sequence of compressed digital image frames from the video signal received in the set top box; and
directing the sequence of compressed digital image frames to a software decompressor that reconstitutes non-compressed digital image frames and writes the non-compressed digital image frames to a graphics memory.

15. The method of claim 1 further comprising the steps of:
determining in the head end the extents of the video presentation window included in the page description;
sending the extents to the set top box; and
receiving the extents in the set top box.

16. The method of claim 15 wherein the step of rendering a video image is accomplished by rendering the video image within the extents received from the head end.

17. The method of claim 15 wherein the extents comprise the size of the video presentation window and the location of one corner of the window within the page image.

18. The method of claim 15 wherein the extents comprise the location of a first corner of the video presentation window within the page image and the location of a second corner of the video presentation window within the page image.

19. The method of claim 1 wherein said display memory in said set top box comprises a background plane and an overlay plane and the step of rendering a video image in said display memory is accomplished by writing video frames into said background plane and making the overlay plane transparent in the region corresponding to the video frames written in the background plane.

20. The method of claim 1 wherein said display memory in said set top box comprises a background plane and an overlay plane and the step of rendering a video image in said display memory is accomplished by writing video frames into the overlay plane.

21. The method of claim 1 wherein said display memory in said set top box comprises a background plane and an overlay plane and the step of painting the page image description frame in said display memory is accomplished by writing the page image description frame into said background plane.

22. The method of claim 1 wherein said display memory in said set top box comprises a background plane and an overlay plane and the step of painting the page image description frame in said display memory is accomplished by writing the page image description frame into said overlay plane and making a region of said overlay plane corresponding to a video presentation window transparent.

23. A set top box capable of receiving video comprising:
page image receiver that receives a page image frame;
page image painter that accepts the page image frame and creates an image of said frame in a display memory;
video signal receiver that receives a video signal; and
video image render engine that accepts the video signal and creates successive frame images in said display memory that correspond to said video signal.

24. The set top box of claim 23 wherein the page image receiver receives the page image frame as a digital image.

25. The set top box of claim 23 wherein the page image receiver receives the page image frame as a video signal.

26. The set top box of claim 23 wherein the page image receiver comprises a digital data interface.

27. The set top box of claim 23 wherein the page image receiver comprises:
tuner for selectively receiving radio frequency modulated carriers;
multi-state demodulator that receives a multi-state modulated carrier from the tuner and demodulates said carrier into a serial data stream containing a plurality of data channels; and
program selector that extracts a specific data channel containing the page image.

28. The set top box of claim 27 wherein the multi-state demodulator determines output data states based on the phase variance of the radio frequency modulated signals.

29. The set top box of claim 27 wherein the multi-state demodulator determines output data states based on the amplitude variance of the radio frequency modulated signals.

30. The set top box of claim 27 wherein the multi-state demodulator determines output data states based on the phase and amplitude variance of the radio frequency modulated signals.

31. The set top box of claim 23 wherein the page image receiver comprises:
tuner for selectively receiving radio frequency modulated carriers;
multi-state demodulator that receives a multi-state modulated carrier from the tuner and demodulates said carrier into a serial data stream containing a plurality of video program channels; and
program selector that extracts a specific video program channel containing the page image.

32. The set top box of claim 31 wherein the multi-state demodulator determines output data states based on the phase variance of the radio frequency modulated signals.

33. The set top box of claim 31 wherein the multi-state demodulator determines output data states based on the amplitude variance of the radio frequency modulated signals.

34. The set top box of claim 31 wherein the multi-state demodulator determines output data states based on the phase and amplitude variance of the radio frequency modulated signals.

35. The set top box of claim 23 wherein the video signal receiver comprises:
tuner for selectively receiving radio frequency modulated carriers;
multi-state demodulator that receives a multi-state modulated carrier from the tuner and demodulates said carrier into a serial data stream containing a plurality of video program channels; and
program selector that extracts a specific video program channel containing the page image.

36. The set top box of claim 35 wherein the multi-state demodulator determines output data states based on the phase variance of the radio frequency modulated signals.

37. The set top box of claim 35 wherein the multi-state demodulator determines output data states based on the amplitude variance of the radio frequency modulated signals.

38. The set top box of claim 35 wherein the multi-state demodulator determines output data states based on the phase and amplitude variance of the radio frequency modulated signals.

39. The set top box of claim 23 wherein the video signal receiver receives a compressed digital video stream.

40. The set top box of claim 39 wherein the video image render engine further comprises a hardware decompressor that:
accepts a sequence of compressed digital image frames from the video signal receiver;
reconstitutes non-compressed digital image frames; and
writes the non-compressed digital image frames to the display memory.

41. The set top box of claim 39 wherein the video image render engine further comprises a software decompressor that:
accepts a sequence of compressed digital image frames from the video signal receiver;
reconstitutes non-compressed digital image frames; and
writes the non-compressed digital image frames to the display memory.

42. The set top box of claim 39 wherein the compressed digital video stream is an MPEG stream.

43. The set top box of claim 23 wherein the video image render engine accepts display extents and creates said frame images in said display memory within the display extents.

44. The set top box of claim 3 wherein the display extents comprise the size of the video presentation window and the location of one corner of the window within the page image.

45. The set top box of claim 3 wherein the display extents comprise the location of a first corner of the video presentation window within the page image and the location of a second corner of the video presentation window within the page image.

46. The set top box of claim 23 wherein said display memory comprises a background plane and an overlay plane and the video image render engine writes video frames into said background plane and makes the overlay plane transparent in the region corresponding to the video frames written in the background plane.

47. The set top box of claim 23 wherein said display memory comprises a background plane and an overlay plane and the video image render engine writes video frames into said into the overlay plane.

48. The set top box of claim 23 wherein said display memory comprises a background plane and an overlay plane and wherein the page image painter writes the page image frame into the background plane.

49. The set top box of claim 23 wherein said display memory comprises a background plane and an overlay plane and wherein the page image painter writes the page image frame into the overlay plane and wherein the overlay plane is made transparent in a region corresponding to a video window.

50. A head end for distributing video to a set top box comprising:
page image render unit that accepts a page description written in a page description language and creates a page image frame according to the description;
page image transmitter that conveys the page image frame to the distribution system; and
video routing unit that receives video signals and forwards the video signals to a distribution system

51. The head end of claim 50 wherein the video signal received by the video routing unit comprises a compressed digital video stream.

52. The head end of claim 51 wherein the compressed digital video stream is an MPEG stream.

53. The head end of claim 50 wherein the page image transmitter is a multi-state modulator.

54. The head end of claim 53 wherein the multi-state modulator modulates the phase of a carrier signal according to the data to be transmitted.

55. The head end of claim 53 wherein the multi-state modulator modulates the amplitude of a carrier signal according to the data to be transmitted.

56. The head end of claim 53 wherein the multi-state modulator modulates the amplitude and phase of a carrier signal according to the data to be transmitted.

57. A system for delivering video to a set top box comprising:
distribution system;
head end comprising:
page image render unit that accepts a page description written in a page description language and creates a page image frame according to the description;
page image transmitter that conveys the page image frame to the distribution system; and
video routing unit that receives video signals and forwards the video signal to the distribution system; and
set top box comprising:
page image receiver that receives a page image frame;
page image painter that accepts the page image frame and creates an image of said frame in a display memory;
video signal receiver that receives a video signal; and
video image render engine that accepts the video signal and creates successive frame images in said display memory that correspond to said video signal.

58. The system of claim 57 wherein the video signal received by the video routing unit comprises a compressed digital video stream.

59. The system of claim 58 wherein the compressed digital video stream is an MPEG stream.

60. The system of claim 57 wherein the page image transmitter is a multi-state modulator.

61. The system of claim 60 wherein the multi-state modulator modulates the phase of a carrier signal according to the data to be transmitted.

62. The system of claim 60 wherein the multi-state modulator modulates the amplitude of a carrier signal according to the data to be transmitted.

63. The system of claim 60 wherein the multi-state modulator modulates the amplitude and phase of a carrier signal according to the data to be transmitted.

64. The system of claim 57 wherein the page image receiver receives the page image frame as a digital image.

65. The system of claim 57 wherein the page image receiver receives the page image frame as a video signal.

66. The system of claim 57 wherein the page image receiver comprises a digital data interface.

67. The system of claim 57 wherein the page image receiver comprises:
tuner for selectively receiving radio frequency modulated carriers;
multi-state demodulator that receives a multi-state modulated carrier from the tuner and demodulates said carrier into a serial data stream containing a plurality of data channels; and
program selector that extracts a specific data channel containing the page image.

68. The system of claim 67 wherein the multi-state demodulator determines output data states based on the phase variance of the radio frequency modulated signals.

69. The system of claim 67 wherein the multi-state demodulator determines output data states based on the amplitude variance of the radio frequency modulated signals.

70. The system of claim 67 wherein the multi-state demodulator determines output data states based on the phase and amplitude variance of the radio frequency modulated signals.

71. The system of claim 57 wherein the page image receiver comprises:
tuner for selectively receiving radio frequency modulated carriers;
multi-state demodulator that receives a multi-state modulated carrier from the tuner and demodulates said carrier into a serial data stream containing a plurality of video program channels; and
program selector that extracts a specific video program channel containing the page image.

72. The system of claim 71 wherein the multi-state demodulator determines output data states based on the phase variance of the radio frequency modulated signals.

73. The system of claim 71 wherein the multi-state demodulator determines output data states based on the amplitude variance of the radio frequency modulated signals.

74. The system of claim 71 wherein the multi-state demodulator determines output data states based on the phase and amplitude variance of the radio frequency modulated signals.

75. The system of claim 57 wherein the video signal receiver comprises:
tuner for selectively receiving radio frequency modulated carriers;
multi-state demodulator that receives a multi-state modulated carrier from the tuner and demodulates said carrier into a serial data stream containing a plurality of video program channels; and
program selector that extracts a specific video program channel containing the page image.

76. The system of claim 75 wherein the multi-state demodulator determines output data states based on the phase variance of the radio frequency modulated signals.

77. The system of claim 75 wherein the multi-state demodulator determines output data states based on the amplitude variance of the radio frequency modulated signals.

78. The system of claim 75 wherein the multi-state demodulator determines output data states based on the phase and amplitude variance of the radio frequency modulated signals.

79. The system of claim 57 wherein the video signal receiver receives a compressed digital video stream.

80. The system of claim 79 wherein the video image render engine further comprises a hardware decompressor that:
accepts a sequence of compressed digital image frames from the video signal receiver;
reconstitutes non-compressed digital image frames; and
writes the non-compressed digital image frames to the display memory.

81. The system of claim 79 wherein the video image render engine further comprises a software decompressor that:
accepts a sequence of compressed digital image frames from the video signal receiver;
reconstitutes non-compressed digital image frames; and
writes the non-compressed digital image frames to the display memory.

82. The system of claim 79 wherein the compressed digital video stream is an MPEG stream.

83. The system of claim 57 wherein the video image render engine accepts display extents and creates said frame images in said display memory within the display extents.

84. The system of claim 83 wherein the display extents comprise the size of the video presentation window and the location of one corner of the window within the page image.

85. The system of claim 83 wherein the display extents comprise the location of a first corner of the video presentation window within the page image and the location of a second corner of the video presentation window within the page image.

86. The system of claim 57 wherein said display memory comprises a background plane and an overlay plane and the video image render engine writes video frames into said background plane and makes the overlay plane transparent in the region corresponding to the video frames written in the background plane.

87. The system of claim 57 wherein said display memory comprises a background plane and an overlay plane and the video image render engine writes video frames into said into the overlay plane.

88. The system of claim 57 wherein said display memory comprises a background plane and an overlay plane and wherein the page image painter writes the page image frame into the background plane.

89. The system of claim 57 wherein said display memory comprises a background plane and an overlay plane and wherein the page image painter writes the page image frame into the overlay plane and wherein the overlay plane is made transparent in a region corresponding to a video window.
